(19) United States
(12) Patent Application Publication
(10) Pub. No.: US 2025/0371717 A1
(43) Pub. Date: Dec. 4, 2025

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventors: Takahiro DOZONO, Tokyo (JP); Motoki KITAZAWA, Tokyo (JP); Yasuyuki YAMAZAKI, Tokyo (JP)

(21) Appl. No.: 19/208,836

(22) Filed: May 15, 2025

(30) Foreign Application Priority Data
May 31, 2024 (JP) 2024-089459

(51) Int. Cl. G06T 7/20; G06V 10/25

(52) U.S. Cl. CPC G06T 7/20; G06V 10/25; G06T 2207/20132; G06V 2201/07

(57) ABSTRACT

An information processing device has a crop region determining unit configured to determine crop regions for images that have been acquired in a time series; a cropping unit configured to generate cropped images from the images according to the crop regions; and a tracking region detection unit configured to detect tracking regions for the subject in the cropped images; wherein the crop region determining unit determines the crop region for a current frame such that the tracking target is included in the crop region for the current frame based on the tracking region that has been calculated by the tracking region detection unit for the previous frame.

### TECHNICAL FIELD

The present disclosure relates to an information processing device, an information processing method, a storage medium, and the like.

### DESCRIPTION OF THE RELATED ART

A large variety of methods have been proposed in which a machine such as a computer or the like studies images as data and recognizes object regions. Such recognition methods are referred to as recognition tasks in this context.

As recognition tasks, there are, for example, detection tasks in which a part of a body of a human (a head, a face, an upper body, and entire body, and the like) are detected from images, tracking tasks in which a specific subject is searched for and tracked from within images, and the like. When it is possible to specify a region of an object in an image using detection tasks and tracking tasks, it is possible for example, to focus a lens of a camera on this region.

In addition, it is possible to appropriately adjust the exposure of this region. There is thereby a dramatic increase in the operability of the camera for the user. Note that this technology is not limited to cameras, and can also be applied to a variety of uses.

A neural network (written below as an “NN”) is known as a technology for learning and executing recognition tasks such as those described above. NN is an abbreviation of Neural Networks. Deep (having a larger number of layers) multilayer NNs are referred to as deep NNs (DNNs).

DNN is an abbreviation of Deep Neural Networks. In particular, deep convolutional neural networks are referred to as DCNNs. DCNN is an abbreviation of Deep Convolutional Neural Networks.

It is known that DCNNs have a high functionality (detection precision, detection function). In addition, in recent years, a technology referred to as a vision transformer, which combines an attention mechanism with image recognition, has been gaining attention.

In a case in which recognition tasks are used in the AF (autofocus) and the like of a camera, in addition to requiring high-speed responsiveness, there are constraints on the scale of the circuits that can be installed on the device, and therefore, there are limits on the computing resources. Therefore, the input resolution cannot be made very high for NNs that are installed on a device.

In contrast, in AF for cameras, it is desirable to be able to focus on local regions of a subject such as an eye of a human, an eye of an animal, a nose of an airplane, and the like. Generally, local regions are small in comparison to the entirety of a subject, and it is therefore desirable to perform processing in a state in which the local portion has been captured at a high resolution.

In addition, during a tracking task as well, if the size of the subject within an image is large, the amount of information increases, and therefore, an increase in tracking precision can also be expected. Therefore, it is preferable to perform processing in a state in which the subject has been image captured at a high resolution.

In order to achieve both of these states, during, for example, a tracking task, which is one type of recognition task, detection results for a subject from a previous frame and the tracking results are used to calculate a crop region that includes this primary subject for input data. In addition, an image (referred to below as a cropped image) is generated in which the crop region has been resized and a region has been cut out in which scaling (referred to below as resizing) has been performed from the input data, and tracking processing is performed. In the same manner, the processing for a detection task for a local region is also performed on a cropped image.

As one method for generating a cropped image from input data, there is a method in which the size (for example, the area) of a region in which the primary subject exists is made the reference, and a crop range is calculated by performing fixed multiplication on this.

One benefit of a cropped image generating method that uses area as a base is that even if there are differences in the regions in which the primary subject exists in the time series data, it is possible to constantly maintain the region in which the primary subject exists that is displayed in the cropped image. In a case in which the region in which the subject exists is a rectangle (a bounding box), cropping may also be performed using the height and width of the rectangle as the reference.

In addition, in Japanese Unexamined Patent Application, First Publication No. 2010-11441, a tracking task for a subject is performed using a DCNN, the degree of difficulty for the tracking is quantified based on whether or not an object exists in the background that is the same color as the surroundings of the output results for the tracking tasks, and whether or not the size of tracking target region is small, and the crop range is calculated based on the degree of difficulty for the tracking.

In addition, in Japanese Unexamined Patent Application, First Publication No. 2023-110521, in a multi-task DCNN that performs the plurality of tasks of tracking tasks and detection tasks for detailed portions of the primary subject, crop ranges are learned using time series data, and an optimal crop range is estimated from output results for the tracking task and the detection task.

However, in a method in which a cropped image is generated using the size of the region in which the primary subject exists as the reference, in a case in which the local region of the primary subject exists on an edge of the primary subject, there is a possibility that this local region will not be included in the range of the cropped image. In particular, in a case in which the primary subject is in a landscape orientation or a portrait orientation, if the size of the crop range is set using the area as the reference there are cases in which the local region will not be included in the crop region.

In such a state in which the local region exists outside of the cropped image, it becomes such that the local area is excluded from the processing target and therefore, it is becomes impossible to detect the local region. In addition, even in the next frame and after, the state in which the local region has not been detected in the cropped image that is used when detecting the region in which the primary subject exists will continue.

The image processing device according to one aspect of the present disclosure comprises:
a crop region determining unit configured to determine crop regions for images acquired in a time series;
a cropping unit configured to generate cropped images from the images according to the crop regions; and
a tracking region detection unit configured to detect tracking regions for a tracking target in the cropped images;
wherein the crop region determining unit is configured to determine the crop region for a current frame such that the tracking target is included in the crop region for the current frame based on the tracking region that has been calculated by the tracking region detection unit for a previous frame.

Further features of the present disclosure will become apparent from the following description of embodiments with reference to the attached drawings.

### BRIEF DESCRIPTION OF THE DRAWINGS

FIG. 1A is a diagram showing a hardware configuration example for an information processing device 110 according to a First Embodiment, and FIG. 1B is a functional block diagram showing a configurational example of the functional blocks of the information processing device according to the First Embodiment.

FIG. 2 is a diagram for exampling a data flow in the information processing device 110 in the First Embodiment.

FIG. 3 is a flowchart showing a processing example in the information processing device 110 according to the First Embodiment.

FIGS. 4A, and 4B are diagrams showing a processing flow for crop reference region determination in the First Embodiment.

FIG. 5A is a functional block diagram showing an example of a functional configuration of an information processing device 502 according to a Second Embodiment, and FIG. 5B is a diagram for explaining a data flow in the information processing device 502 according to the Second Embodiment.

FIG. 6 is a flowchart showing a processing example in the information processing device 502 according to the Second Embodiment.

FIGS. 7A, and 7B are diagrams for explaining processing examples for crop reference region determination in the Second Embodiment.

FIGS. 8A, and 8B are diagrams for explaining a flow for processing for the crop reference region determination in a Third Embodiment.

FIGS. 9A, and 9B are diagrams for explaining a processing flow for crop reference region determination in a Fourth Embodiment.

FIG. 10 is a flowchart showing a processing example for an information processing device according to the Fourth Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

Note that, in the explanation below, the time for when a video image frame (abbreviated below to a frame) has been acquired is represented by t, and the frame image that is acquired first is written as t=1, the time for the current frame image is written as t=T, the time for the previous frame image that is one frame before the current frame is t=T−1, the time for the next preceding frame image after the current frame is written as t=T+1, and the like.

In addition, the model in which learning has been completed in advance in the explanation given below refers to a model that has learned DCNN (Deep Convolution Neural Networks) so as to be able to detect a subject that becomes a detection target.

In addition, below, an explanation is given of an example in which, for example, a vehicle that is image captured by a camera is tracked as a subject, and detection is parallelly performed for a specific part of the subject (for example, the nose of an airplane, referred to below as a local region). However, the subject is not limited to a vehicle, and may also be applied to for example, a head or an ankle of a human being, a head or a tail of an animal, or the like.

### First Embodiment

In the First Embodiment, in a case in which the detection precision for the position and size of the tracking region are insufficient, a crop region is calculated using the detection results for a local region and the tracking region of the subject.

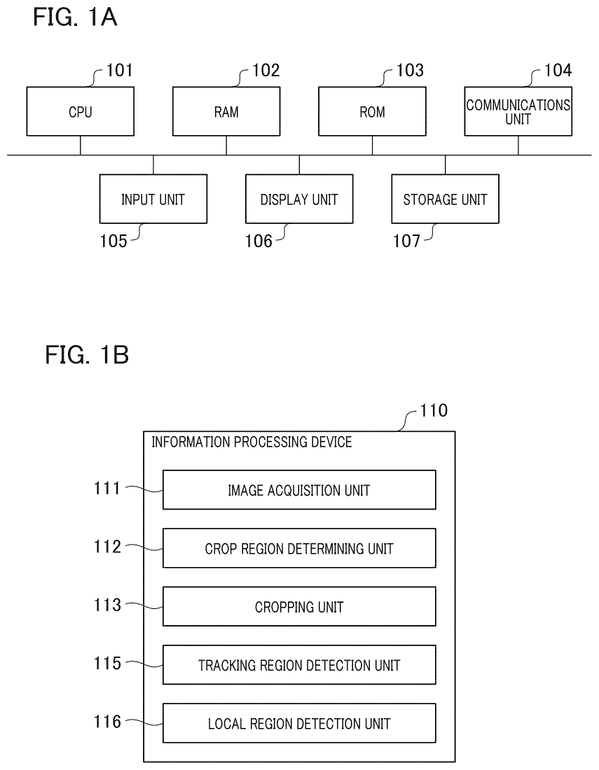

FIG. 1A is a diagram showing a hardware configuration example of the information processing device 110 according to the First Embodiment. In FIG. 1A, the control of the entirety of the information processing device is performed by a CPU 101 that functions as a computer executing a control-use computer program that is stored on a ROM 103.

A RAM 102 is the primary memory of the CPU 101, is used as a temporary storage region such as a work area and the like, expands a computer program for use in control, and makes a state in which the computer program can be executed by the CPU 101. An input unit 105 is configured by a keyboard and touch panel, and the like, receives input from the user, and is able to receive image input and the like.

A display unit 106 is configured by a liquid crystal display and the like, and is able to display each type of data and processing results to the user. In addition, the information processing device 110 is able to perform communications with other devices via a communications unit 104, and the information processing device 110 acquires image input and pre-learned models from other devices, and receives commands from the user via the communications unit 104. In addition, the processing results for the information processing device 110 are output to other devices.

A storage unit 107 stores the data that is used in the processing of the present embodiment, and stores, for example, learned models. An HDD, a flash memory, each type of optical media, and the like can be used as the medium for the storage unit 107.

In the present embodiment, a region in which a subject that serves as a tracking target exists (referred to below as a tracking region) and a local region, which are calculated by a pre-learned DCNN, are used, and a box (for example, a crop reference region) is calculated that will be used as a reference when determining the crop region.

FIG. 1B is a functional block diagram showing a configurational example of functional blocks of the information processing device according to the First Embodiment. Note that a portion of the functional blocks that are shown in FIG. 1B are realized by a CPU or the like that functions as a computer and is included in the information processing device executing a computer program that has been stored on a memory that serves as a storage medium.

However, a portion or the entirety thereof may also be made so as to be realized by hardware. An application-specific integrated circuit (ASIC), a processor (a reconfigurable processor, a DSP), and the like can be used as the hardware.

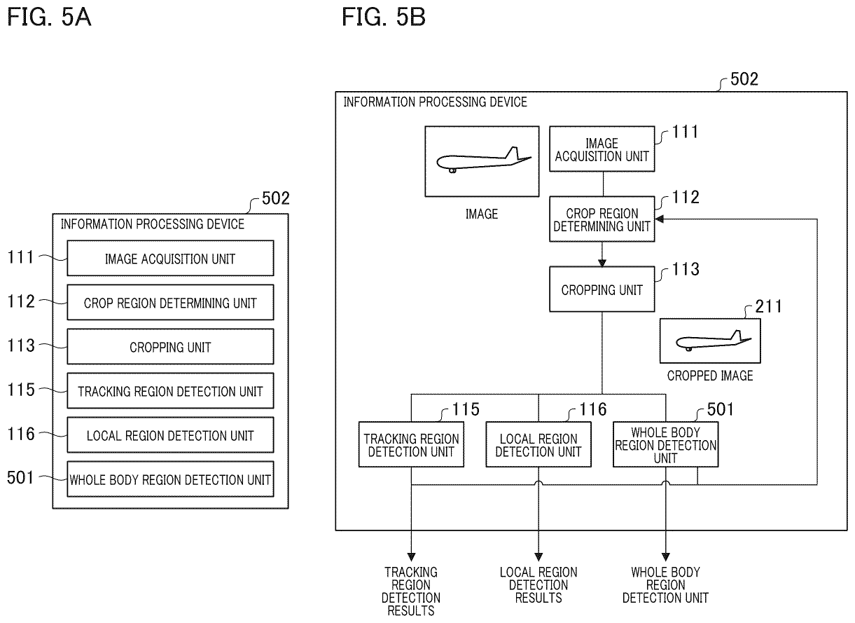

In addition, each of the functional blocks that are shown in FIG. 1B do not need to be housed in the same body, and may also be configured by separate devices that have been connected to each other via signal paths. Note that the above explanation relating to FIG. 1B also applies in the same manner to FIG. 5A.

In FIG. 1B, the input of time series data from the user is received in an image acquisition unit 111. Information that is output from a tracking region detection unit 115 and a local region detection unit 116 that will be described below is used and the crop region for the next frame is determined in a crop region determining unit 112. That is, the crop region determining unit 112 determines crop regions for images that have been acquired in a times series.

A cropping unit 113 generates a cropped image from a frame image based on the crop region that has been determined in the crop region determining unit 112.

A pre-learned DCNN is used and a region in which the subject exists within the crop region is calculated in the tracking region detection unit 115 as a rectangle in which the four values of the x coordinate, the y coordinate, the height, and the width for the central coordinates of the tracking region are maintained as the parameters.

In this context, the tracking region detection unit 115 detects a tracking region for a tracking target within a cropped image. Note that it is sufficient if the information that is held as the parameters for the rectangle of the tracking region can be expressed as a rectangle, and this information is not limited to above-described four parameters.

A pre-learned DCNN is used and a region in which a local region (for example, the nose of a plane) of the subject exists within the cropped image is calculated in the local region detection unit 116 as a rectangle in which the four values of the x coordinate, the y coordinate, the height, and the width of the central coordinates of the local region are maintained as the parameters.

In the same manner as for the output of the tracking region detection unit 115, it is sufficient if the information that is held as the parameters for the rectangle of the local region can be expressed as a rectangle, and this information is not limited to the four parameters described above, Note that the local region detection unit 116 functions as a local region detection unit configured to detect at least one local region of a tracking target.

The pre-learned models that are used in the tracking region detection unit 115 and the local region detection unit 116 may use one pre-learned model that has learned a multitask in which a plurality of recognition tasks is performed, or a plurality of pre-learned models that specialize in each recognition task may also be used.

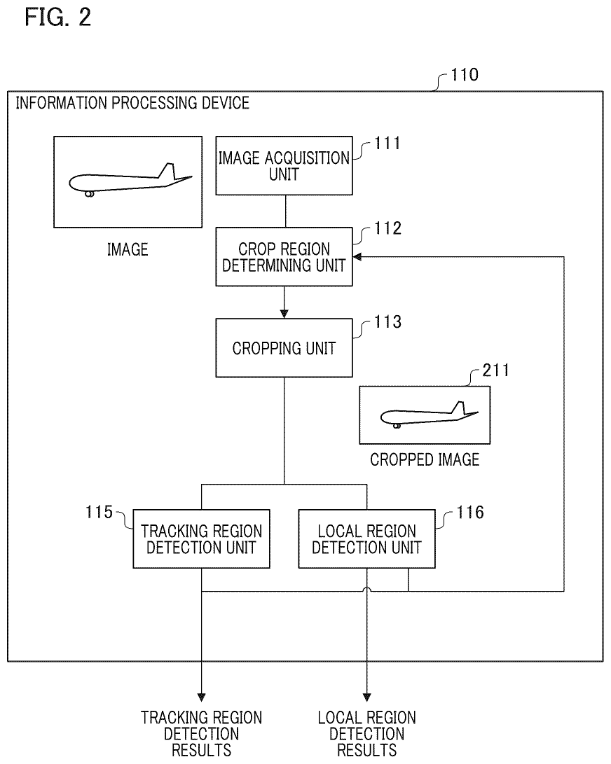

Next, the processing flow for the information processing device 110 according to the present embodiment will be explained using FIGS. 2 to 4.

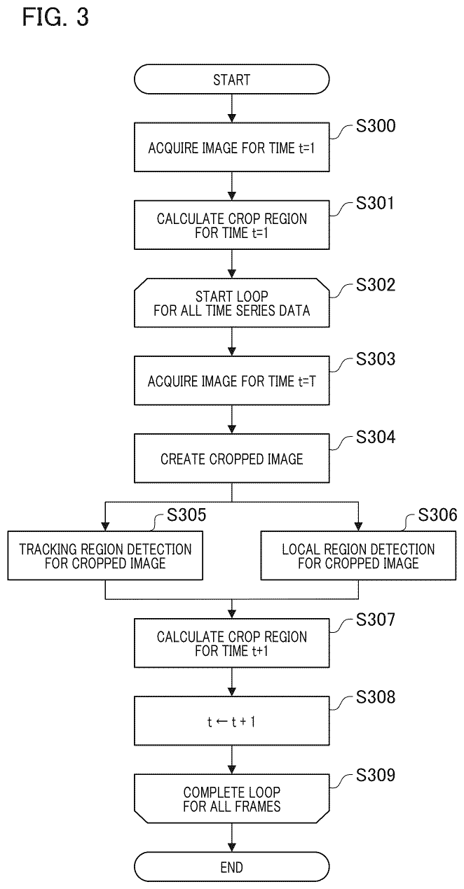

FIG. 2 is a diagram for explaining a flow of data in the information processing device 110 of the First Embodiment, and FIG. 3 is a flowchart showing a processing example in the information processing device 110 in the First Embodiment.

Note that the operations for each step of the flowchart in FIG. 3 are performed in order by the CPU and the like that functions as a computer inside of the information processing device 110 executing a computer program that has been stored on a memory.

During step S300 of FIG. 3, the image acquisition unit 111 acquires the image for the time t=1. During step S301, the crop region determining unit 112 determines a crop region for the frame that was acquired during the time t=1. Note that step S301 functions together with the step S307, which will be described below, as a crop region determining step configured to determine crop regions for images that have been acquired in a time series.

Note that in order to determine the crop region, although the region in which the subject exists (referred to below as the crop reference region) for the previous frame is necessary, a previous frame does not exist for the time t=1, and therefore this cannot be used. Therefore, it is necessary for the user to use any type of method to perform the initial settings for the region in which the subject exists.

For example, a region having a set size may be determined as the region in which the subject exists using the central position of the input image as reference. Conversely, an object that is near to coordinates in the input image that have been indicated by the user may also be determined by using the results that have been detected by a DCNN that has learned an object detection task in advance.

Note that in the present embodiment, the crop region is made a rectangle that maintains the four parameters of the x coordinate, the y coordinate, the height, and the width for the central coordinates in an input image coordinate system. In addition, upon a region being determined to be the region in which the subject exists, a constant multiple (for example, two times, or the like) of the area of the region in which the subject exists is determined as the crop region.

During step S302, a loop begins for the entirety of the time series data that is input. Specifically, the processing for step S303 to step S308 is repeated. During step S303, the image acquisition unit 111 acquires the image for the time t=T.

During step S304, the cropping unit 113 generates a cropped image from the crop region. Note that step S304 functions as a cropping step configured to generate a cropped image from the image according to the crop region.

During the time t=1, the cropped image is generated from the crop region that was calculated during step S301. During the time t=T(t≠1), a cropped image 211, as is shown in, for example, FIG. 2, is generated from the crop region that was calculated during step S306 for the time t=T−1, which is the previous frame.

In the present embodiment, although an explanation is given of an example in which a crop region that was calculated one frame previously is used, a crop region from two or more frames previously may also be used. In a case in which the frame rate is high and in a case in which the movements of the subject are small, this allows for a greater decrease in the processing amount.

The cropped image is input into the tracking region detection unit 115, and the local region detection unit 116, which are pre-learned DCNNs. In a case in which the DCNNs are realized by hardware such as circuits and the like, it is preferable that the image size for the input data is a fixed value, and therefore, the image size for the cropped image 211 is made a size that will be a fixed size throughout the entirety of the frames regardless of the area of the crop region.

For example, it is assumed that the original image size before cropping is performed is a full HD size (1920×1200 pixels), and the image size for the input data for the DCNNs is a VGA size (640×480 pixels). In this case, the cropped images are resized so as to become, for example, a VGA sized image size throughout all of the frames.

During step S305, the cropped image 211 for the time t=T that was generated during step S303 is made the input, and the tracking region for the subject is calculated in the tracking region detection unit 115. In this context, step S305 functions as a tracking region detection step configured to detect a tracking region for a tracking target in the cropped image.

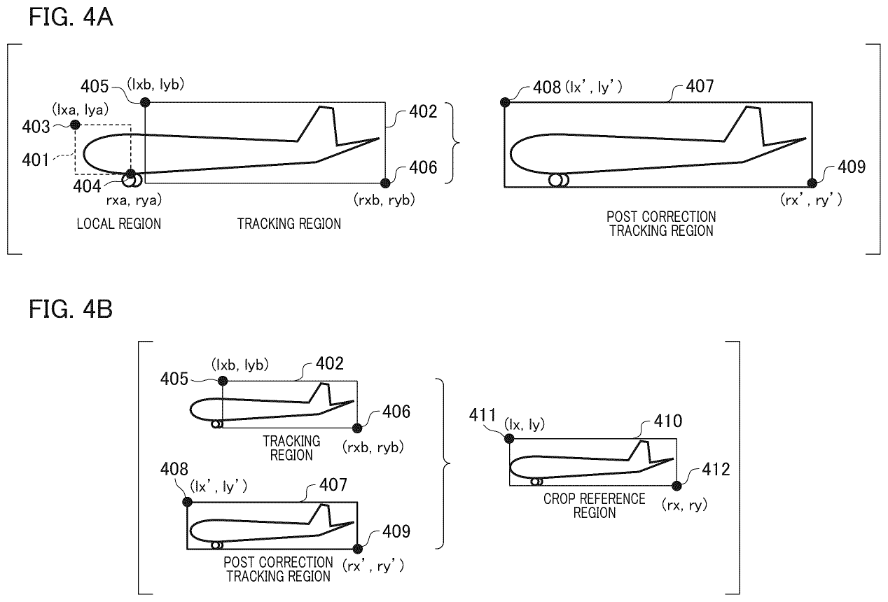

FIGS. 4A, and 4B are diagrams showing flows for processing for the crop reference region determination in the First Embodiment. In the explanation given below, as is shown in FIG. 4A, in the tracking region 402, the upper left end point 405 of the tracking region is made (lxb, lyb), and the lower right end point 406 of the tracking region is made (rxb, ryb).

During step S306, the cropped image 211 for the time t=T that was generated during step S303 is made the input, and the local region for the subject is calculated in the local region detection unit 116.

In the explanation given below, as is shown in FIG. 4A, in the local region 401, the upper left end point 403 of the local region is made (lxa, lya), and the lower right end point 404 of the local region is made (rxa, rya).

During step S307, the tracking region 402 that was calculated during step S305, and the local region 401 that was calculated during step S306 are used, and the calculation for the crop region during the time t=T+1 is performed, Note that step S307 functions together with the step S301 as a crop region determination step configured to determine crop regions for images that have been acquired in a time series.

When performing this determination, in a case in which the detection precision for the tracking region is not sufficiently high, if a crop region is used in which the detection results for the tracking region are made the crop reference region, there is a chance that this will become an incorrect crop region.

Therefore, during step S307 of the present embodiment, the crop reference is determined using not just the detection results for the tracking region but also the detection results for the local region. The processing for step S307 will be explained using FIG. 4.
(i) First, a post correction tracking region 407 of FIG. 4A is calculated so as to include the local region 401 and the tracking region 402 from the four points in FIG. 4A of the upper left end point 403 of the local region, the bottom right end point 404 of the local region, the upper left end point 405 of the tracking region, and the bottom right end point 406 of the tracking region. That is, the following Formula 1 and Formula 2 are used to calculate an upper left end point 408 of the post correction tracking region (lx′, ly′), and a bottom right end point 409 of the post correction tracking region (rx′, ry′) for the post correction tracking region 407.

$${lx}^{′} = min ( lxa , lxb ) \begin{matrix} & {ly}^{′} = min ( lya , lyb )\end{matrix} \qquad ( Formula 1 )$$

$$\begin{matrix}{rx}^{′} = max ( rxa , rxb ) & {ry}^{′} = max ( rya , ryb )\end{matrix} \qquad ( Formula 2 )$$

(ii) Next, the crop reference region 410 of FIG. 4B is calculated from the four points of the upper left end point 408 of the post correction tracking region, the lower right end point 409 of the post correction tracking region, the upper left end point 405 of the tracking region, and the lower right end point 406 of the tracking region, which were calculated during (i).

That is, the following Formula 3 and Formula 4 are used and the upper left end point 411 of the reference region and the lower right end point 412 of the reference region for the crop reference region 410 are calculated as weighted sums. Note that a in the Formula 3 and the Formula 4 represents the weight (degree of importance) for the tracking region 402 in relation to the crop reference region 410, and is defined as a range from 0 to 1.

$$\begin{matrix}lx = lxb ⋆ α + {lx}^{′} ⋆ ( 1 - α ) & ly = lyb ⋆ α + {ly}^{′} ⋆ ( 1 - α )\end{matrix} \qquad ( Formula 3 )$$

$$\begin{matrix}r x = rxb ⋆ α + {rx}^{′} ⋆ ( 1 - α ) & ry = ryb ⋆ α + {ry}^{′} ⋆ ( 1 - α )\end{matrix} \qquad ( Formula 4 )$$

Note that in the present embodiment, although an example is shown in which a weighted sum is used for the local region and the tracking region, correction does not necessarily need to be performed using weighted sums. For example, the size and position of the post correction tracking region 407, which includes the entirety of the local region and the tracking region, may also be used as the crop reference. In addition, in this case, the post correction tracking region 407 does not need to be a rectangle.
(iii) After this, a region that is a fixed multiple (for example, 1.2 times) of the area of the crop reference region 410 is determined to be the crop region for the time t=T+1. The magnification value that is used when determining the crop region can be set by the user in advance.

Note that when determining the crop region, in a case in which the crop region is larger than the VGA size, this is resized and made smaller, or up to a region of the size of the cropped image 211 is used as the crop region. Conversely, in a case in which the crop region is smaller than the VGA size, this is resized and expanded.

Note that although in the present embodiment, the crop region was determined using a fixed multiple of the area of the crop reference region 410, the determination is not limited thereto. For example, the crop region may also be determined based on the length of the long sides of the crop reference region 410.

In this manner, during step S307, the crop region for the current frame is determined by the crop region determining unit 112 such that the tracking target is included in the crop region for the current frame based on the tracking region in the previous frame that was calculated by the tracking region detection step.

In addition, in the First Embodiment, step S307 determines the crop region based on the tracking region and at least one local region.

Returning to FIG. 3, during step S308, the crop region that was calculated during the time t=T is held, and the processing transitions to the processing for the frame for the time t=T+1.

Next, the processing proceeds to step S309, and if the processing for step S303 to step S308 has not been completed for all of the frames, the processing returns to step S302. Then step S302 to step S309 are repeated until the processing for step S303 to step S308 has been completed for all of the frames. In a case in which the loop processing has been completed for all of the frames during step S309, the flow for FIG. 3 is ended.

In the present embodiment, the crop region is determined so as to include the local region in the cropped image by using the two detection results for the tracking region and the local region in the calculation of the crop reference region. It is thereby possible to also be able to respond to circumstances in which the detection precision for the position and the size of the tracking region is not sufficient when generating the cropped image with the goal of detecting the local region of the subject in each frame.

### Second Embodiment

In the First Embodiment, although the detection results for the tracking region and the local region were used when calculating the crop reference region, there is also a possibility that the detection precision for the position and size of both the tracking region and the local region will be insufficient. In this context, in the Second Embodiment, detection of a whole body region for the tracking target is performed along with the detection for the tracking region and the local region, and the crop region calculation is performed using the detection results for the whole body region, the tracking region, and the local region.

FIG. 5A is a functional block diagram showing a configurational example of the information processing device 502 in the Second Embodiment. In FIG. 5A, in addition to the tracking region detection unit 115 and the local region detection unit 116, a whole body region detection unit 501 is also included that detects a whole body region of the subject that is the tracking target.

FIG. 5B is a diagram for explaining the flow of data in the information processing device 502 of the Second Embodiment, and the tracking region detection unit 115, the local region detection unit 116, and the whole body region detection unit 501 each perform detection processing on the cropped image 211.

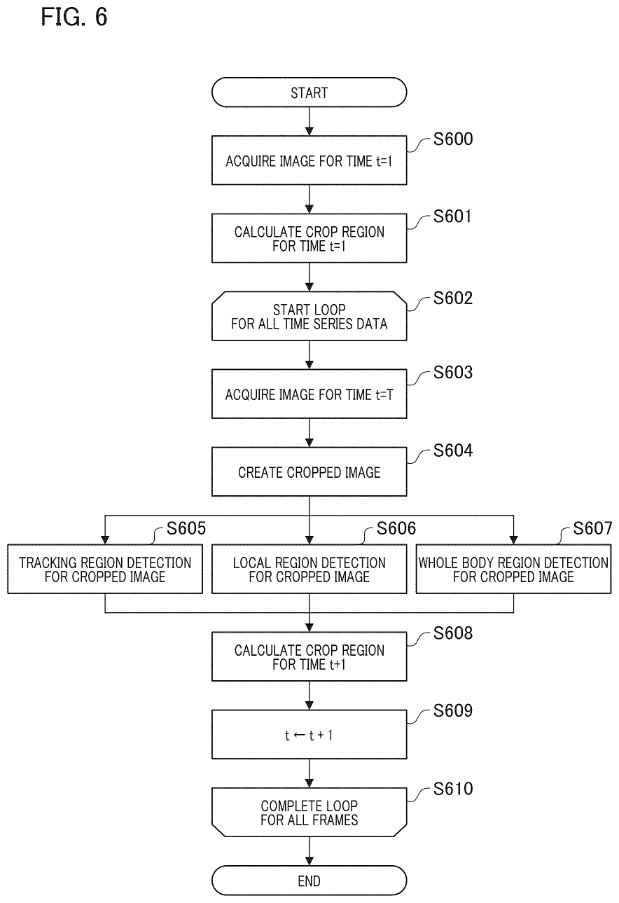

FIG. 6 is a flowchart showing a processing example for the information processing device 502 of the Second Embodiment. Note that the operations for each step of the flowchart in FIG. 6 are performed in order by the CPU and the like that serves as a computer inside of the information processing device 502 executing a computer program that has been stored on a memory.

Steps S600 to S606, step S609, and step S610 of FIG. 6 are the same as steps S300 to S306, step S308, and step S309 of FIG. 3, and therefore, explanations thereof will be omitted. Below, step S607 and step S608 will be explained.

During step S607, the cropped image 211 from the time t=T that was generated during step S604 is input, and the whole body region for the subject is calculated in the whole body region detection unit 501.

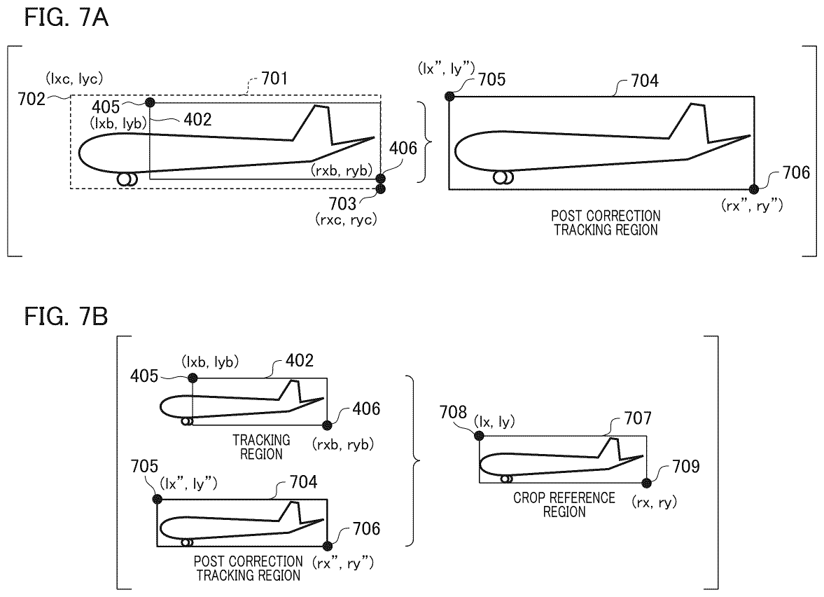

FIGS. 7A, and 7B are diagrams for explaining a processing example for the crop reference region determination in the Second Embodiment. As is shown in FIG. 7A, in the whole body region 701 that is calculated in the whole body region detection unit 501, a upper left end point 702 of the whole body region is made (lxc, lyc), and a region lower right end point 703 of the whole body is made (rxc, ryc).

In contrast, in the tracking region 402, in the same manner as in the First Embodiment, the upper left end point 405 of the tracking region is made (lxb, lyb), and the lower right end point 406 of the tracking region is made (rxb, ryb).

During step S608, the whole body region 701 for the subject that was calculated during step S607 and, for example, the tracking region 402 are used, and the calculation of the crop region for the time t=T+1 is performed. That is, during step S608, the crop region is determined by the crop region determining unit 112 based on the tracking region and the whole body region. The processing that occurs during this step will be explained using FIG. 7.
(i) First, a post correction tracking region 704 is calculated so as to encircle the whole body region 701 and the tracking region 402 from the four points of FIG. 7A of the upper left end point 702 of the whole body region, the lower right end point 703 of the whole body region, the upper left end point 405 of the tracking region, and the tracking region lower right end point 406. That is, the upper left end point 705 of the post correction tracking region (lx″, ly″) and the lower right end point 706 of the post correction tracking region (rx″, ry″) for the post correction tracking region 704 are calculated using the following Formula 5 and Formula 6.

$$\begin{matrix}{lx}^{″} = min ( lxc , lxb ) & {ly}^{″} = min ( lyc , lyb )\end{matrix} \qquad ( Formula 5 )$$

$$\begin{matrix}{rx}^{″} = max ( rxc , rxb ) & {ry}^{″} = min ( ryc , ryb )\end{matrix} \qquad ( Formula 6 )$$

(ii) Next, the crop reference region 707 of FIG. 7B is calculated from the four points of the upper left end point 705 of the post correction tracking region, the lower right end point 706 of the post correction tracking region, the upper left end point 405 of the tracking region, and the lower right end point 406 of the tracking region.

That is, an upper left end point 708 of the reference region for the crop reference region 707, and a lower right end point 709 of the reference region for the crop reference region 707 are calculated as weighted sums using the following Formula 7 and Formula 8. β in the Formula 7 and Formula 8 represents a weight (degree of priority) for the tracking region 402 in relation to the crop reference region 707, and is defined within a range of 0 to 1.

$$\begin{matrix}lx = lxb ⋆ β + {lx}^{″} * ( 1 - β ) & ly = lyb ⋆ β + ly ⋆ ( 1 - β )\end{matrix} \qquad ( Formula 7 )$$

$$\begin{matrix}rx = rxb ⋆ β + rx ⋆ ( 1 - β ) & ry = ryb ⋆ β + ry ⋆ ( 1 - β )\end{matrix} \qquad ( Formula 8 )$$

(iii) Next, in the same manner as the processing that was explained for step S305 in the First Embodiment, a region that is a constant multiple of the area of the crop reference region 707 is determined as the crop region for the time t=T+1.

As has been explained above, in the Second Embodiment, the crop region is calculated such that the local region is included in the cropped image by using two sets of detection results, for example, the detection results for the tracking region and the detection results for the whole body region. However, during step S608, the calculation for the crop region during the time t=T+1 may also be performed using the whole body region 701 for the subject that was calculated during step S607, and at least one of the tracking region 402 and the local region 401.

In the Second Embodiment, by performing the processing in this manner, it is possible to respond even to circumstances in which the detection precision for the position and size of both the tracking region and the local region are insufficient when generating a cropped image with the goal of detecting a local region of a subject in each frame.

### Third Embodiment

For example, in the First Embodiment, a method was shown in which the crop region was determined such that the entire body of the subject including the local region exists inside of the cropped image by using the coordinates for the upper left end points and the lower right end points of both the local region and the tracking region, and calculating an upper left end point and a lower right end point for the crop reference region.

However, the primary goal of correcting the crop reference region is to include the local region within the cropped image, and therefore, there is no need for the entire body of the subject to necessarily exist within the cropped image. As a specific example, there are cases in which the nose, which corresponds to the local region, of an airplane exists within the cropped image, but the tail of the airplane is not included in the cropped image.

In this context, in the Third Embodiment, the central coordinates for the local region and the central coordinates for the tracking region are used, the central coordinates for the crop reference region are calculated, and the crop region is calculated such that at least the local region is included in the cropped image. That is, the crop region determining unit 112 determines the crop region based on the central position of the local region and the central position of the tracking region.

Although the flowchart for the processing in the Third Embodiment is the same as that in FIG. 3, the processing during step S304 and Step S305 is different than in the First Embodiment, and therefore, an explanation will be given of step S304 and step S305.

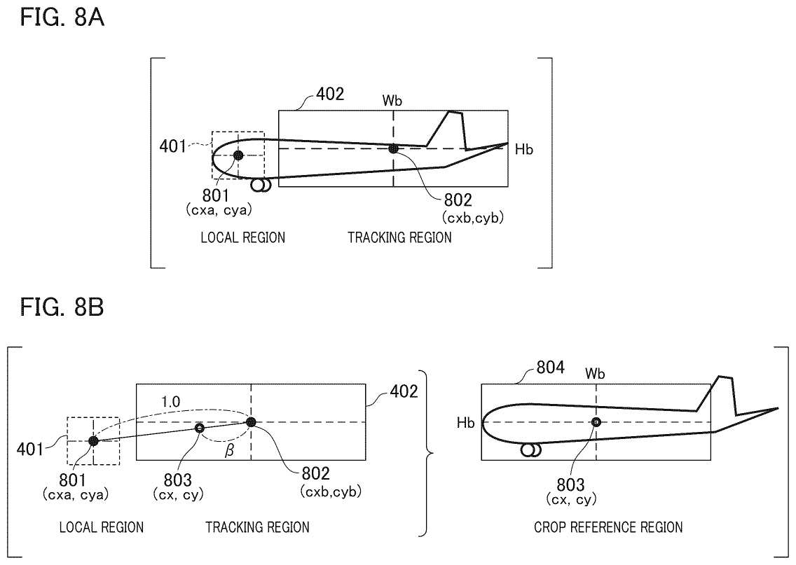

FIGS. 8A, and 8B a diagrams explaining a flow of the processing for the crop reference region determination in the Third Embodiment. During step S304 of the Third Embodiment, when the cropped image is being generated, the central coordinates and the like for the local region 401 and for the tracking region are acquired as is shown in FIG. 8A.

That is during step S304, the x coordinate and the y coordinate for the central coordinates 801 of the local region 401, which are (cxa, cya), as well as the x coordinate, the y coordinate, the height, and the width of the central coordinates 802 of the tracking region, which are (cxb, cyb, Wb, Hb) are acquired.

In addition, during step S305 in the Third Embodiment, coordinates that have been corrected such that the central coordinates 802 for the tracking region 402 approach the central coordinates 801 for the local region 401 are calculated as the central coordinates 803 for the crop reference region, as is shown in FIG. 8B.

Specifically, a displacement width for the central coordinates for the local region 401 from when the distance between the centers for the central coordinates 801 of the local region 401 and the central coordinates 802 of the tracking region 402 have been made 1, is made β, and the central coordinates 803 for the crop reference region 804 (cx, cy) are calculated in the manner of the following Formula 9. β is set between 0 and 1.

$$\begin{matrix}cx = cxa ⋆ β + cxb ⋆ ( 1 - β ) & cy = cxa ⋆ β + cxb ⋆ ( 1 - β )\end{matrix} \qquad ( Formula 9 )$$

The width and the height of the crop reference region 804 are made Wb and Hb, which are the height and the width of the tracking region 402, and the x coordinate, the y coordinate, the height, and the width for the central coordinates of the crop reference region 804 that are calculated during step S305 are made (cx, cy, Wb, Hb).

In addition, the region of the fixed multiple of the area of the crop reference region 804 that has been calculated is determined as the crop region for the time t=T+1.

In this manner, in the Third Embodiment, the crop reference region is calculated from the central coordinates for the local region and the tracking region, and the height and width of the tracking region. It is thereby possible to determine the crop region so as to include at least the local region in the cropped image when generating a cropped image with the goal of detecting a local region for a subject in each frame.

### Fourth Embodiment

In the Fourth Embodiment, when determining the crop region for the next frame based on the area of the crop reference region that has been calculated for the current frame, correction is performed such that the ratios for the size and aspect of the crop reference region become less than or equal to a predetermined threshold value.

That is, in the Fourth Embodiment, in a case in which the aspect ratio for the tracking region is larger than the predetermined threshold value, the crop region determining unit 112 corrects the crop region.

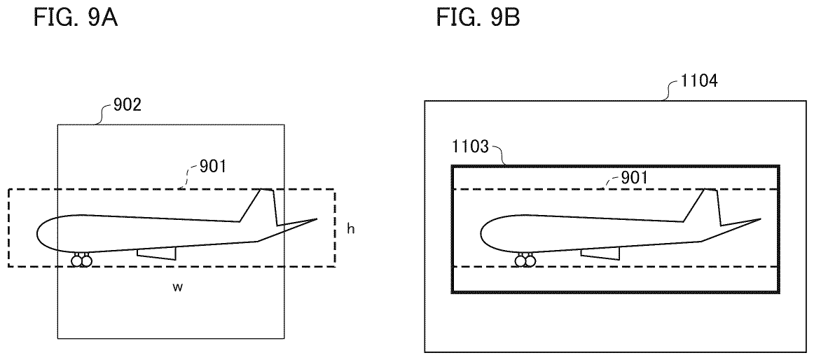

FIGS. 9A, and 9B are diagrams for explaining the flow of the processing for the crop reference region determination in the Fourth Embodiment. As is shown in FIG. 9A, there are cases in which even if the crop reference region 901 including the local region has been calculated by the First Embodiment to the Third Embodiment, the local region is still excluded from the crop region 902 due to the aspect ratio for the crop reference region.

In this context, in the Fourth Embodiment, for example, a threshold value is provided for the aspect ratio of the crop reference region, and in a case in which the aspect ratio is larger than this threshold value, the crop reference region is corrected such that the local region is necessarily included in the crop region.

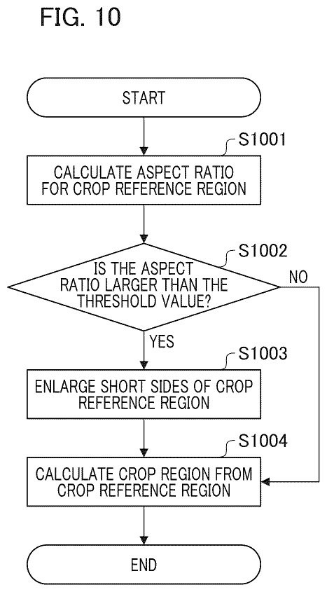

FIG. 10 is a flowchart showing a processing example for the information processing device of the Fourth Embodiment. Note that the operations for each step of the flowchart in FIG. 10 are performed in order by the CPU and the like that serves as the computer inside of the information processing device 110 executing a computer program that has been stored on a memory.

Although the processing for the Fourth Embodiment is the same as the flow in FIG. 3, the processing shown in the flowchart in FIG. 10 is performed during step S301 and step S305 of FIG. 3. Note that the processing for step 305 for the time t=T will be explained using FIG. 10.

During step S1001, the parameters for the crop reference region for t=T are acquired, and the aspect ratio is calculated. Note that the parameters that are acquired in this context may be the aspect ratio for the crop reference region that has been calculated using any of the First Embodiment to the Third Embodiment, or they may also be the aspect ratio for the tracking region in the cropped image that was generated during step S304.

However, the aspect ratio is made a value that can be used to calculate the height and width of the crop reference region, such as the x coordinates and the y coordinates for the upper left end point and the upper right end point of a box. Note that in the example of the Fourth Embodiment, it is assumed that the crop reference region that is acquired during step S305 is a rectangle having an aspect ratio such as that shown by the crop reference region 901 of FIG. 9A.

During step S1002, it is determined whether or not the aspect ratio for the crop reference region 901 that was acquired during step S1001 is larger than the predetermined threshold value that has been set in advance, In a case in which Yes has been determined during step S1002, the processing proceeds to step S1003, and in a case in which No has been determined during step S1002, the processing proceeds to step S1004.

During step S1003, the length of the short sides of the crop reference region is enlarged in the manner of FIG. 9B such that the aspect ratio for the crop reference region 901 becomes the threshold value aspect ratio. For example, in a case in which threshold value aspect ratio is 4:1, and the width of the crop reference region 901 is 700 while the height of the crop reference region 901 is 100, the height of the crop reference region is enlarged to 175 in the same manner as for the post correction crop reference region 1103 shown in FIG. 9B, and corrections are performed such that the aspect ratio becomes the threshold value aspect ratio.

Note that although in the Fourth Embodiment the length of the short sides of the crop reference region is enlarged, the present disclosure is not limited thereto, and it is sufficient if the aspect ratio for the post correction crop reference region 1103 becomes equal to or less than the predetermined threshold value

During step S1004, the crop region 1104 for FIG. 9B is calculated from the post correction crop reference region 1103, which is equal to or less than the threshold value aspect ratio, in the same manner as in the First Embodiment to the Third Embodiment. In this manner, in the Fourth Embodiment, the crop reference region is calculated by correcting the length of the short sides of the tracking region based on the aspect ratio for the tracking region.

Therefore, it is possible to calculate the crop region such that the local region will necessarily be included in the cropped image regardless of the detection precision for the positions and sizes of both the local region and the whole body region. Note that although in the Fourth Embodiment, the aspect ratio for the crop reference region is corrected so as to be equal to or less than the predetermined threshold value, the aspect ratio for the crop region may also be corrected.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device and the like through a network or various storage media. Then, a computer (or a CPU, an MPU, or the like) of the information processing device and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-089459, filed on May 31, 2024, which is hereby incorporated by reference herein in its entirety.

What is claimed is:

1. An information processing device comprising at least one processor or circuit configured to function as:
a crop region determining unit configured to determine crop regions for images acquired in a time series;
a cropping unit configured to generate cropped images from the images according to the crop regions; and
a tracking region detection unit configured to detect tracking regions for a tracking target in the cropped images;
wherein the crop region determining unit is configured to determine the crop region for a current frame such that the tracking target is included in the crop region for the current frame based on the tracking region that has been calculated by the tracking region detection unit for a previous frame.

2. The information processing device according to claim 1, wherein the at least one processor or circuit is further configured to function as:
a local region detection unit configured to determine at least one local region of the tracking target; and wherein
the crop region determining unit is configured to determine the crop region based on the tracking region and the at least one local region.

3. The information processing device according to claim 2, wherein the crop region determining unit is configured to determine the crop region such that the tracking region and the at least one local region are included in the crop region for the current frame.

4. The information processing device according to claim 2, wherein the crop region determining unit is configured to correct a tracking region that has been calculated by the tracking region detection unit for the previous frame so as to include the tracking region and the at least one local region; and
is configured to determine the crop region based on the tracking region that has been corrected and the tracking region that has been calculated.

5. The information processing device according to claim 2, wherein the crop region determining unit is configured to determine the crop region based on a central position of the local region and a central position of the tracking region.

6. The information processing device according to claim 1, wherein the at least one processor or circuit is further configured to function as:
a whole body region detection unit configured to detect a whole body region of the tracking subject; and wherein
the crop region determining unit is configured to determine the crop region based on the tracking region and the whole body region.

7. The information processing device according to claim 1, wherein the crop region determining unit is configured to correct the crop region in a case in which an aspect ratio for the tracking region is larger than a predetermined threshold value.

8. An information processing method comprising:
determining crop regions for images acquired in a time series;
generating cropped images from the images according to the crop regions; and
detecting tracking regions for a tracking target in the cropped images; wherein
during the crop region determining, the crop region for a current frame is determined such that the tracking target is included in the crop region for the current frame based on the tracking region that has been calculated during the tracking region detecting for a previous frame.

9. A non-transitory computer-readable storage medium storing a computer program including instructions for executing following processes:
determining crop regions for images acquired in a time series;
generating cropped images from the images according to the crop regions; and
detecting tracking regions for a tracking target in the cropped images; wherein
during the crop region determining, the crop region for a current frame is determined such that the tracking target is included in the crop region for the current frame based on the tracking region that has been calculated during the tracking region detecting for a previous frame.
